(19) United States
(12) Patent Application Publication
(10) Pub. No.: US 2007/0033535 A1
(43) Pub. Date: Feb. 8, 2007

(54) System and method for information entry in report section

(76) Inventor: Louis G. Cornacchia III, Point Lookout, NY (US)

Correspondence Address: F. CHAU & ASSOCIATES, LLC, 130 WOODBURY ROAD, WOODBURY, NY, 11797, US

(21) Appl. No.: 11/498,953

(22) Filed: Aug. 3, 2006

Related U.S. Application Data
(63) Continuation-in-part of application No. 11/083,865, filed on Mar. 18, 2005.
(60) Provisional application No. 60/718,103, filed on Sep. 16, 2005.

(51) Int. Cl. G06F 17/30

(52) U.S. Cl. 715/762; 715/780; 707/10

(57) ABSTRACT

A computer-based method is provided for media or data entry into a section of a report via an electronic network. The method includes: displaying a graphical user interface (GUI) comprising information indicating a plurality of program processes; receiving first user input selecting a first program process from the plurality of program processes; marking a first insertion point in the report section at a first user-selected position, the first user-selected position being selectable to allow a user to insert data at any position in the report section; and entering a first data into the report section at the first insertion point using the first program process.

### CROSS-REFERENCE TO RELATED PATENT APPLICATION

This is a Continuation-In-Part Application of U.S. application Ser. No. 11/083,865 (Attorney Docket No. 8123-1), filed Mar. 18, 2005 and entitled “SYSTEM AND METHOD FOR REMOTELY INPUTTING AND RETRIEVING RECORDS AND GENERATING REPORTS,” the content of which is herein incorporated by reference in its entirety.

### BACKGROUND OF THE INVENTION

1. Technical Field

The present disclosure relates to methods and systems for information entry, including media and data into a report; more particularly, a graphical user interface for facilitating the information entry

2. Discussion of Related Art

It has been the practice of professionals, such as doctors, lawyers, and engineers to personally record pertinent information on a subject patient, client or matter so that professional services performed and data pertinent to the subject are documented. The documented information can be in many different forms, such as a patient record database with patient demographic information and clinical data, an engineer's report on the structural conditions of a building, or an invoice including professional fees, travel and other expenses related to the services performed.

In many instances, the professional memorializes the pertinent data or basis for a decision contemporaneously as services are performed, such as by handwritten notes or dictation into a voice recorder, and the information is subsequently gathered for office personnel to enter into a report. Many reports are standardized as forms and the gathered information is filled into the form for efficient reporting. For example, in the case of a physician examining a patient, clinical information is developed during discussions with and physical examination of the patient. The physician dictates or writes the clinical information observed during the examination, and the forms and notes are typically entered by the physician's office personnel. Likewise, the structural engineer dictates or writes his observations during a visual inspection, and a building inspection report is generated by filling in a form-like report with standard pre-filled text on general building condition, supplemented by contemporaneous information using the recorded dictation.

When a patient is examined by a physician, the results of the physical examination or clinical information are routinely recorded such as by the physician entering the information onto a form which is then placed in the patient's history file. It is common practice for the healthcare professional to make handwritten notes during the patient's physical examination. The notes are later used by the healthcare professional for personally dictating a patient's report. The dictation is then transcribed, reviewed and signed by the physician who conducted the patient's physical examination.

In the case of medical offices operating under health maintenance organization (HMO) oversight, requiring audits of the examination notes of medical professionals for consistency and trends in diagnosis and treatment, the lack of computerized databases for monitoring and updating clinical examination data and the time consuming process of re-transcribing and editing paper charts complicates this auditing process.

The Standards for Privacy of Individually Identifiable Health Information (“Privacy Rule”) limits the circumstances in which an individual's protected health information may be used or disclosed. The Privacy Rule, which was published in final form on Aug. 14, 2002, establishes, for the first time, a set of national standards for the protection of certain health information. The U.S. Department of Health and Human Services issued the Privacy Rule to implement the requirement of the Health Insurance Portability and Accountability Act of 1996 (HIPAA).

A major purpose of the Privacy Rule is to define and limit the circumstances in which an individual's protected health information may be used or disclosed. The Privacy Rule requires that health plans, healthcare clearinghouses, and every healthcare provider, regardless of size, who electronically transmits health information shall maintain reasonable and appropriate administrative, technical and physical safeguards to ensure the integrity and confidentiality of the information, protect against any reasonably anticipated threats or hazards to the security or integrity of the information, and protect against unauthorized uses or disclosures or the information.

Medical record documentation systems that allow the use of dictation as a means of documenting clinical data are known. In conventional systems, only predefined methodologies and predetermined data sources are available to users. The restriction to predefined methodologies and the lack of user-centric workflows force users into a learning curve that affects user productivity, endangers the quality of healthcare, interferes with the doctor-patient relationship, and results in low user satisfaction and low adoption rates of these systems.

Despite the advances in the art, there is a need for a system and method for allowing a user to enter data, such as clinical data, into a report using a variety of methodologies and technologies and various data sources as appropriate for a situation and the needs of the user. A need exists for a system and method of managing medical records for concurrently recording patient history and/or examination notes during patient examination. A need also exists for a system and method of managing medical records that allows the physician to document the medical information by a variety of methods over a global electronic network to improve medical documentation quality, efficiency, availability and security, with lower costs.

### SUMMARY OF THE INVENTION

According to an exemplary embodiment of the present invention, a computer-based method is provided for media or data entry into a section of a report via an electronic network. The method includes: displaying a graphical user interface (GUI) comprising information indicating a plurality of program processes; receiving first user input selecting a first program process from the plurality of program processes; marking a first insertion point in the report section at a first user-selected position, the first user-selected position being selectable to allow a user to insert data at any position in the report section; and entering a first data into the report section at the first insertion point using the first program process.

According to an exemplary embodiment of the present invention, a computer-based method is provided for media or data entry into a section of a report. The method includes: receiving first user input selecting a report; receiving second user input selecting a report section; generating a list of section entry methods based on the type of report section selected by a user; displaying the section entry method (SEM) list; receiving third user input selecting a SEM from the SEM list; enabling functions based on the user-selected SEM; marking a first insertion point in the report section at a first user-selected position, the first user-selected position being selectable to allow a user to insert data at any position in the report section; and entering a first data into the report section at the first insertion point using the user-selected SEM.

According to an exemplary embodiment of the present invention, a graphical user interface is provided for use in entry of information in a medical report via an electronic network. The graphical user interface includes: a plurality of sections presentable to the user including: a first section for entry of patient administration information; a second section presented with data transfer functions including at least one virtual media entry device; a third section presented with a menu of selectable various patient data and data entry and editing functions; and a forth section presented with selectively retrievable clinical data specific to the user.

The present invention will become more apparent to those of ordinary skill in the art when descriptions of exemplary embodiments thereof are read with reference to the accompanying drawings.

### BRIEF DESCRIPTION OF THE DRAWINGS

FIG. 1 illustrates a computer network suitable for use in accordance with an exemplary embodiment of the present invention.

FIG. 2 shows a graphical user interface, according to an exemplary embodiment of the present invention.

FIG. 3 shows an enlarged view of an editor panel of the graphical user interface of FIG. 2 that provides a medical report data entry screen, according to an exemplary embodiment of the present invention.

FIG. 4 shows an enlarged view of a section entry method (SEM) panel of the graphical user interface of FIG. 2 showing SEM menus, according to an exemplary embodiment of the present invention.

FIG. 5 illustrates an example of a medical report showing data entered by section entry methods, according to an exemplary embodiment of the present invention.

FIG. 6 is a flowchart showing a method of data entry into a section of a report as appropriate for a type and source of data and a type of report section, according to an exemplary embodiment of the present invention.

FIG. 7 is a flowchart showing a method of data entry into a section of a report as appropriate for a type and source of data and a type of report section, according to an exemplary embodiment of the present invention.

FIG. 8 is a flowchart showing a method of data entry into a section of a report as appropriate for a type and source of data and a type of report section, according to an exemplary embodiment of the present invention.

FIG. 9 is a screen view of a graphical user interface according to an exemplary embodiment of the present invention.

### DESCRIPTION OF EXEMPLARY EMBODIMENTS

Hereinafter, exemplary embodiments of the present invention will be described in detail with reference to the accompanying drawings. Like reference numerals refer to similar of identical elements throughout the description of the figures.

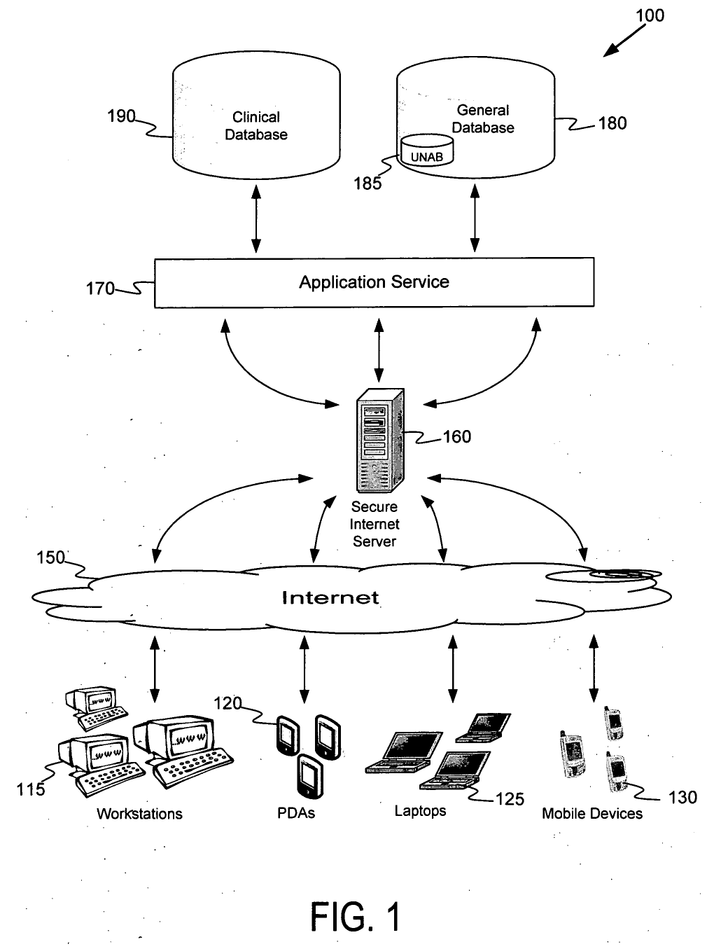

FIG. 1 illustrates a computer network suitable for use in accordance with an exemplary embodiment of the present invention. It should be understood that the elements shown in FIG. 1 may be implemented in various forms of hardware, software or combinations thereof.

Referring to FIG. 1, a computer network 100 includes clinical database 190, general database 180, application service 170, secure Internet server 160, and at least one Internet access device, such as for example, workstation 115, PDA 120, laptop (or notebook) computer 125, or other Microsoft Windows-enabled mobile devices 130. The computer network 100 also includes a software subsystem called the “universal address book”, which maintains information on all entities in the system. In an exemplary embodiment of the present invention, universal address book (UNAB) data 185 is contained in the general database 180.

The information such as person identifying and demographic information stored in the general database 180 may be separated from the data that is stored in the clinical database 190. The general database 180 is designed to be run either integrated with the other database tables or hosted as a separate database system in a geographically different site from the clinical database 190. When hosted separately, a hacker who succeeds at hacking into one site will not obtain the other's information. For example, if a hacker were to hack into the clinical database 190 the hacker would not have the person identifying information. To increase security and privacy, the demographic data and/or clinical data may be encrypted. The connection between the UNAB data 185 and the clinical database 190 may also be encrypted.

The secure Internet server 160 includes modules to facilitate access to/from application service 170 to the various Internet access devices 115, 120, 125 and 130 connected to the network over the Internet 150. The workstations 115, for example, may be a fixed or portable personal computer equipped with a computer monitor or screen, a keyboard, a microphone and/or a camera, software modules for browsing hypertext or hypermedia pages, a set of computer speakers and a computer mouse.

Generally, data or information can be input into the secure Internet server 160 from the various Internet access devices 115, 120, 125 and 130 over the Internet 150 without software specially made for the secure Internet server 160. Specific software that may be needed from time to time can be downloaded from the secure Internet server 160 and installed at the various Internet access devices 115, 120, 125 and 130. For example, security software for user identification or authentication can be loaded at the user's station and used to ensure the user is a registered subscriber. Commercially available software such as VoiceID or Pronexus VBVoice can be used for the speaker identification process.

Secure Internet server 160 may include an instructable data processor which can be coupled to a hard disk, a keyboard, mouse, and/or another form of user interface (e.g., microphone) as well as to a video card and display device, a network interface card, telephony cards and circuits, and random access memory (RAM), where the latter alone or in combination with the hard disk may contain system software which provides instruction signals for instructing the data processor and/or other instructable data processor to carry out machine-implemented operations in accordance with the present disclosure.

When a user logs in and gains access to application service 170, e.g., using an Internet access device 115, 120, 125 or 130 connected to the network over the Internet 150, according to an exemplary embodiment of the present invention, he or she sets up report parameters that may include provider information, organization information, date of service, location of service, etc. The user may be prompted to enter the subject of the report, and a list of existing reports for that subject may be presented. The user may decide whether to create a new report or select an existing report for the entered subject. Examples of report structures and methods of generating a report suitable for use in exemplary embodiments of the present invention are disclosed in co-owned, co-pending U.S. patent application Ser. No. ______, entitled “SELF-ORGANIZING REPORT”, the disclosure of which is herein incorporated by reference in its entirety.

In the case where the user chooses to create a new report, the user may be presented with a list of report types. It will be appreciated that various types of reports are suitable for use in accordance with embodiments of the present invention, including but not limited to medical reports, client reports, engineering reports, research reports, tax reports, accounting reports, accident reports, inventory reports, business reports, insurance reports, financial reports, government reports, or documentation reports, etc.

A report, in accordance with an exemplary embodiment of the present invention, includes a report header, at least one report part, and at least one report section. The report header may contain metadata relating to the entire report, such as for example, person, patient, client, author, entity such as a government entity, physician, engineer, attorney, date, file identifier such as project name, attorney docket number or security classification level, location and so forth. In the case of a medical report, for example, there may be a report part entitled physical exam.

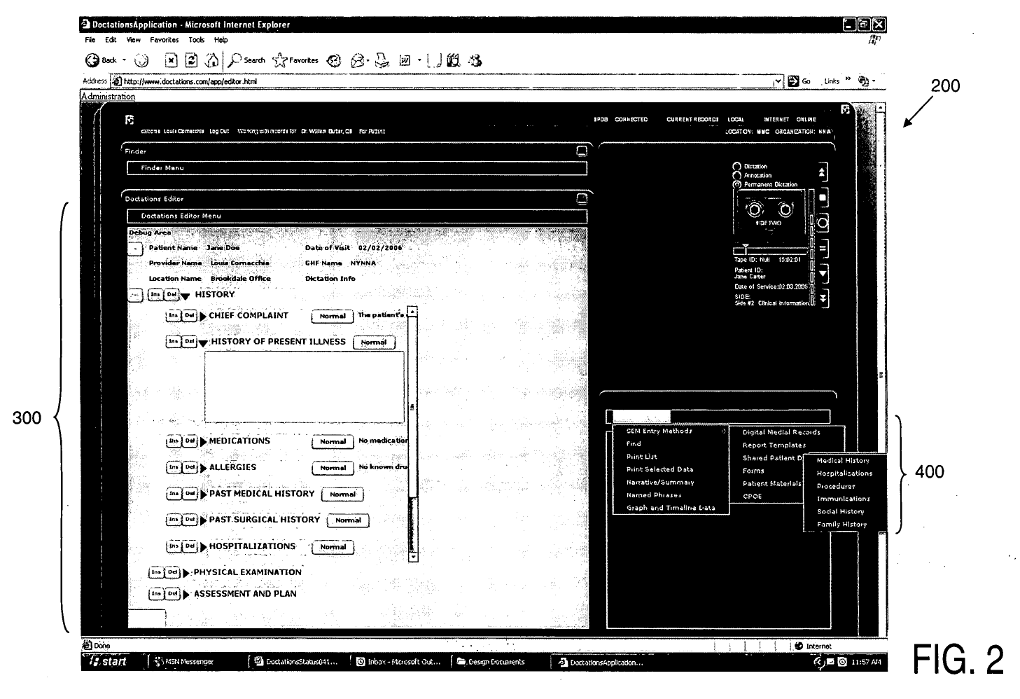

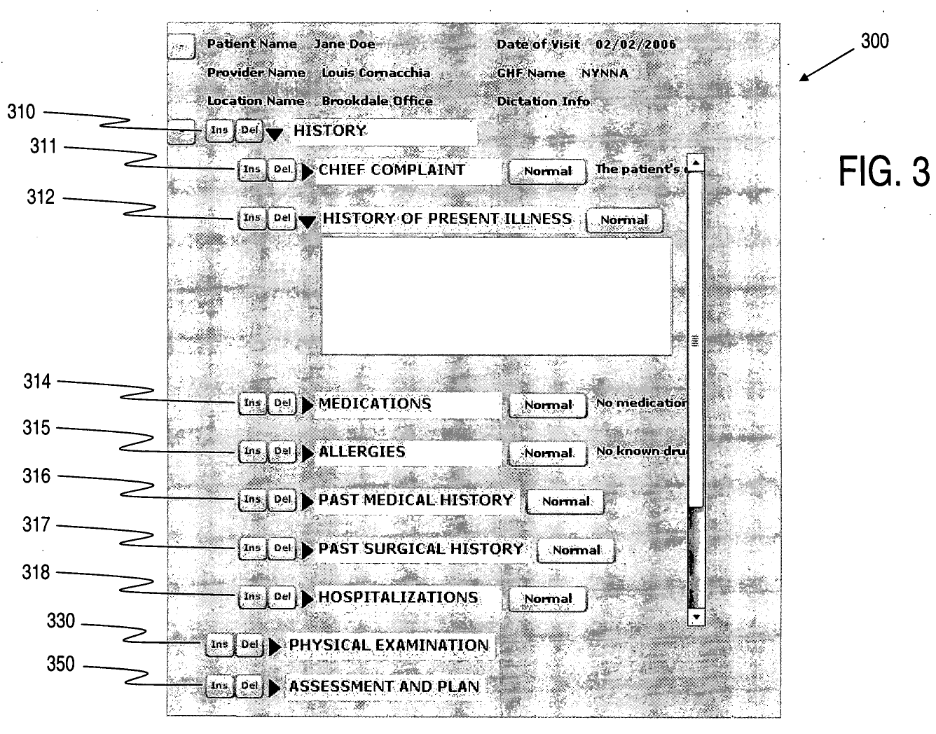

FIG. 3 shows an enlarged view of an editor panel of the graphical user interface of FIG. 2 that provides a medical report data entry screen, according to an exemplary embodiment of the present invention. Referring to FIG. 3, the medical report data entry screen 300 includes report parts entitled: History 310, Physical Examination 330 and Assessment and Plan 350. The History 310 part includes report sections entitled: Chief Complaint 311, History of Present Illness 312, Medications 314, Allergies 315, Past Medical History 316, Past Surgical History 317, and Hospitalizations 318.

The Physical Examination 330 part may contain sections for the chest exam, cardiac exam, abdominal exam, etc. A report section may contain report section data. For example, in a medical report, each report section contains clinical data that documents the information relevant to that section. For example, the data for the cardiac exam section may contain information about an EKG, resting pulse, etc. The section data can include data that was entered by a wide variety of section entry methods as appropriate for the section. Examples of methods of dictating into a report section suitable for use in the present invention are disclosed in co-owned, co-pending U.S. patent application Ser. No. ______, entitled “DICTATE SECTION DATA”, the disclosure of which is herein incorporated by reference in its entirety.

For example, if the report section is Allergies 315, it may be desirable to use the shared patient database which contains a list of allergies for the patient that have been entered and subsequently confirmed by potentially any number of healthcare providers. In general, the more healthcare providers with access to list of allergies, the more providers that review that data with the patient, and it gets increasing accurate over time. Instead of asking the patient, or typing it in from a questionnaire that asked the patient to list his or her allergies, the healthcare provider could “click in” the data from this shared and reviewed-and-confirmed data source, such as for example, clinical database 190.

In the case of a person with no history of allergies who suddenly experiences allergy symptoms and goes to an allergist, the allergist wouldn't have anything from the shared patient database to “click in”. In this case, when the allergy tests are done, the allergist could type in a list of things that the patient reacted to, or dictate it from the test results, or bring up the allergy test results and “click in” right from the test results, for example, by highlighting and copying into the medical document right from the lab report. The medical document could get saved to the patient database for subsequent entry and review by other doctors.

The above description of data entry into a section of a medical report provides examples of data entry methods that are suitable for implementing the present invention. For example, the user could type it in, or dictate it, or dictate it and have the dictation transcribed, or the user could “click in” the data, for example, copy and paste it from a lab report. In the case when the data exists in the patient database, the user could copy it in from the patient's medical history. If the data does not exist in the patient database, but the user has a medical report from two weeks ago with a section on allergies, and the user is doing a follow up after a procedure, the user could, for example, go to that medical report and click in the allergy results. In an exemplary embodiment of the present invention, data is captured from one or more hardware devices, such as for example, an EKG device or a scanner.

Keeping with the allergy example, if one of the reactions is a rash on the patient's arm, instead of trying to verbally describe the rash, a photograph could be taken and imported into the allergy section of the medical record. The allergist could record, for example, “the patient demonstrated a reaction to sulfa compound and here is a picture of the rash.” As opposed to a localized rash on the patient's arm where taking a picture should be fine, if the rash is over the patient's body the user could video cam it and capture not just a single image but an image stream.

When healthcare providers are doing their clinical documentation, there may be a need for more than historical information about the patient. There may be a need for documenting with information other than patient specific information like the rash. For example, as part of the assessment and plan the doctor will make a diagnosis or a preliminary diagnosis and may design a plan to either further refine the diagnosis or, if the diagnosis is firm, to treat the condition. In an exemplary embodiment of the present invention, a section entry method which is appropriate for a medical report is the ability to bring up an order screen where the healthcare provider can order lab tests electronically. Information such as what lab tests were ordered and at which lab could be imported directly into the Assessment and Plan 350 section; for example, “I've ordered a CDC from Quest Diagnostics for Jane Doe.” One of the orders that the doctor wants may be a prescription. According to an exemplary embodiment of the present invention, there is provided a prescription writing interface. For example, the doctor may want to prescribe hydrocortisone crème 1% to be used on the infected area 4× day with one refill. The doctor uses the prescription writing interface to fill out the prescription form. According to an embodiment of the present invention, the prescription writing interface provides the capability to print out the prescription, which may be given to the patient, and/or to submit it electronically to a pharmacy, and/or to capture the information about the prescription in an appropriate section such as the Assessment and Plan 350 section of a medical report. Each of these can be individual clinical documents in the system associated with the patient. The term “clinical document” or “clinical documentation” is a broad description that encompasses many different types of clinical documents. It is to be understood that clinical documents are defined by a type including, but not limited to, an operative report, an E&M (evaluation & management) report, a progress note, and a consult report. The different types of clinical documents may have different sections into which clinical information may be entered.

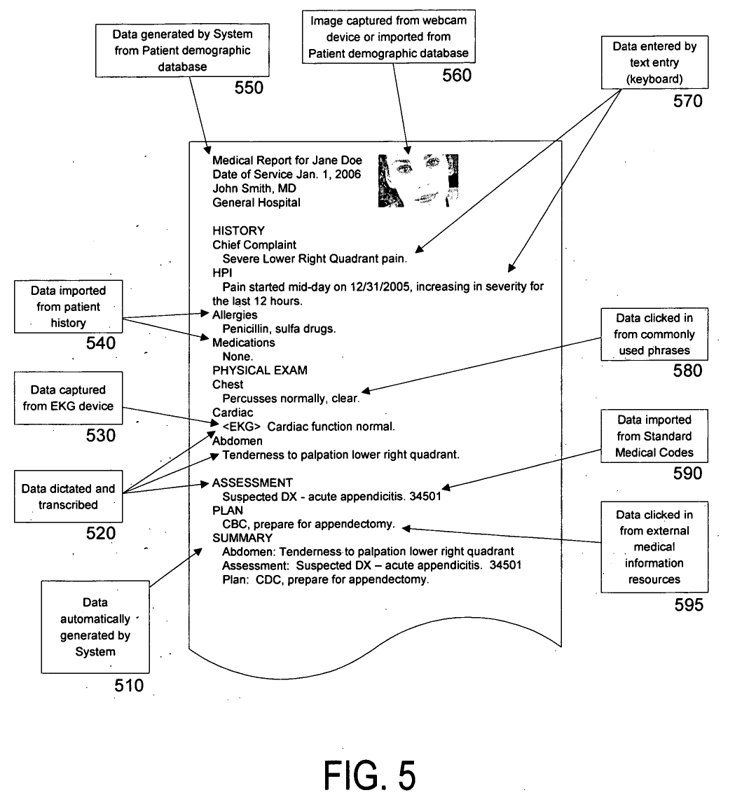

FIG. 5 illustrates an example of a medical report showing data entered by various section entry methods, according to an exemplary embodiment of the present invention. As illustrated in FIG. 5, section entry methods include: data automatically generated by the system as indicated by box 510, data dictated and transcribed as indicated by box 520, data captured from an EGK device as indicated by box 530, data imported from sections of the patient History 310 as indicated by box 540, data generated by the system from a patient demographic database as indicated by box 550, images captured from a webcam device or imported from the patient demographic database as indicated by box 560, data entered by text entry as indicated by box 570, data clicked in from commonly used phrases as indicated by box 580, data imported from standard medical codes as indicated by box 590, and data clicked in from external medical information resources as indicated by box 595.

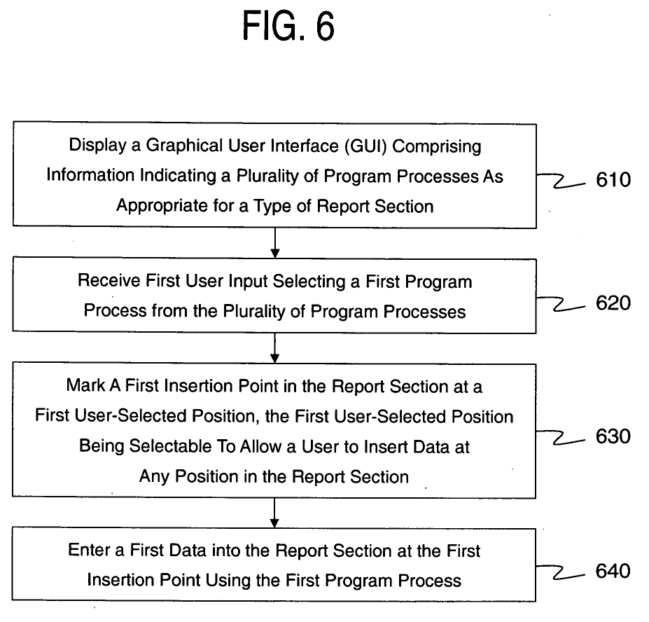

FIG. 6 is a flowchart showing a method of data entry into a section of a report as appropriate for a type and source of data and a type of report section, according to an exemplary embodiment of the present invention.

Referring to FIG. 6, in a step 610, display a graphical user interface (GUI) comprising information indicating a plurality of program processes as appropriate for the type of report section. In an exemplary embodiment of the present invention, the type of report section is selected by the user. The information indicating a plurality of program processes may comprise a list of section entry methods appropriate for the type of report section. Types of section entry methods include, but are not limited to, text entry, dictation, dictation/transcription, voice recordings, video capture, digital image capture, scanned/faxed documents, patient-specific health information, such as for example, allergies, problems, medications and history, other medical documents, such as for example, prior patient medical reports, lab results, and radiological reports, external health information resources, such as for example, treatment protocols, research, medical dictionaries and glossaries, commonly-used text, phrases, objects, standard medical codes and nomenclatures, form-based data entry with or without images, and patient educational materials.

According to exemplary embodiments of the present invention, the graphical user interface is divided into several portions, preferably four quadrants. In accordance with an exemplary embodiment of the present invention, an upper left quadrant comprises a “FRONT DESK”, an upper right quadrant comprises a “Communication Center”, a lower left quadrant comprises a “document editor (DE)”, and a lower right quadrant comprises a “clinical file cabinet (CFC)”. All four quadrants may be visible at start-up. In an exemplary embodiment of the present invention, the quadrants are organized such that information required while creating a document is in the CFC to the right of the DE and both are simultaneously available.

In addition to the four quadrants, there may be a panel of data above which identifies the current user, supervising personnel if applicable, account and GHF as well as current patient. The quadrants comprise mini-windows (also referred to herein as “panes”) which may be initially locked in size. When unlocked, the document editor can expand upwards to cover most of the front desk pane. Likewise, the front desk pane can expand downwards when it becomes “the focus”, for example, to cover a portion of the document editor pane.

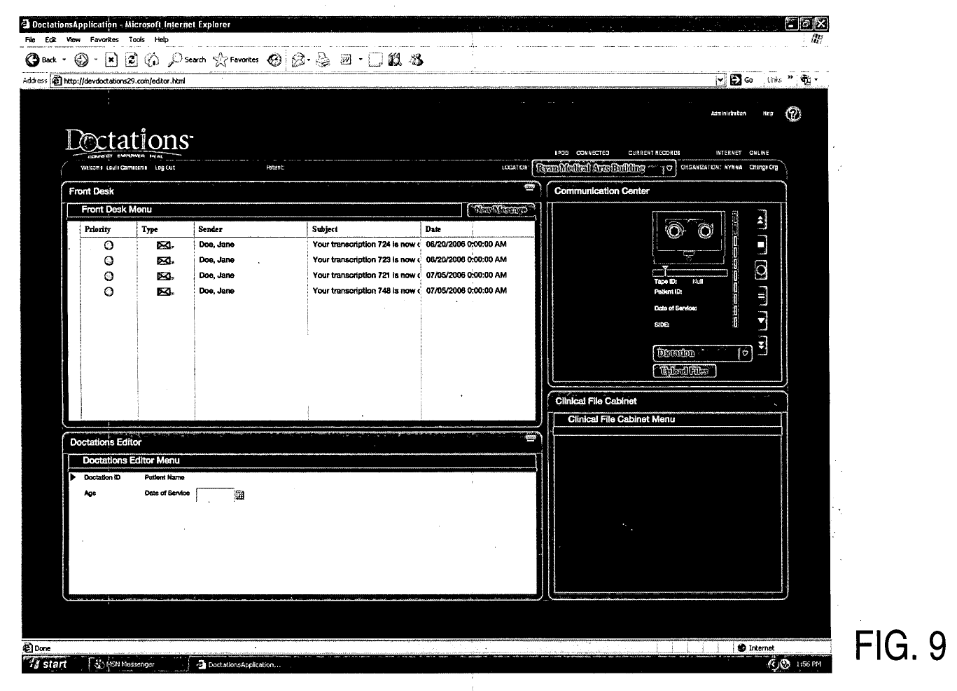

FIG. 9 is a screen view of a graphical user interface that is divided into four quadrants, according to an exemplary embodiment of the present invention. Hereinafter, various exemplary embodiments of the quadrants of the graphical user interface of FIG. 9 will be described.

Upper Left Quadrant=Front Desk

The upper left quadrant is called the “front desk”, which is where administrative information is stored. For example, this quadrant may contain one or more lists of messages, documents requiring signatures, list of signed-in patients with room assignments, schedule data, etc.

Upper Right Quadrant=Communications Center

This area provides controls to access system resources on the user's computer system. System resources include virtual media players and recorders, cameras, microphones, etc. For example, a virtual audio recorder with associated controls can be selected to record a dictation. A virtual camera with camera function buttons can be selected for capturing stills from an attached camera, and/or a video camera for capturing video may be accessed from this quadrant. Also available for selection is a button to transfer video images. There may also be controls that allow the user to browse his/her disk drive and upload files for storage with the patient's chart.

Lower Left Quadrant—Doctations RIA and iTranscribe RIA

This is the area where documents are generated, edited and ultimately electronically signed. This quadrant contains tools such as a spell checker and dictionary. This quadrant works in connection with the upper right quadrant, for example, the communications center, to allow recording of audio, images and video directly into text in a document. For example, the user places an insertion point in the text then clicks the appropriate record button in the upper right quadrant. The result is a font-icon which depicts an audio, image or video recording. The user may play back same by double clicking this icon. The video playback and image play back appear in the communications center. The image or video may be enlarged to fill the upper right quadrant or further enlarged to fill a larger portion of the screen using pop-up windows.

The left lower quadrant also works intimately with the list window in the lower right quadrant, for example, the clinical file cabinet (CFC). The pane can be made to list all of the components of a structure report and these components can then be transferred into the current document by clicking on a control to the left of the item listed in the CFC. The CFC can also be made to list the patient's prior consults and contents of these consults can then be transferred to the current report in a similar manner. The CFC can be made to list labs and imaging study reports and the user can click over references to same along with report summary can be transferred to.

Lower LEFT Quadrant=PATIENT WEBSITE

This quadrant may be modeled after a television with a drop-down channel list and the ability to “channel surf” through channels or directly access a channel by entering a number. Different system functions may be located on specific channels. For example, the patients “current doctor list” may be on channel 2. The patient's current medication list may be on channel 13. The patient's primary doctor's site may be on channel 50. The patient's medical profile may be on channel 3. The patient's Digital Health Record may be on channel 4. Channel 1 may comprise a list of messages for the patient.

In addition, the channels may contain programming content. Channel 1000 may be a summary of new offerings. Channel 1001 may be a video of a physician discussing his approach to the treatment of a disease. The TV may have tools associated with it. For example, there may be a medical dictionary and/or a spelling assistant. The CFC, for example, in the lower right quadrant, may list additional resources available with a particular channel. For example, if Dr. X is giving a presentation on Meniere's disease on channel 1001, then the CFC might contain a list of articles or website links for further research. The upper right corner of the TV screen may contain a mailbox icon. The upper left may contain a question mark icon/watermark. Clicking on the mailbox icon brings up a message pop-up which allows the user to record a video or audio message to the author. This may be followed by an automated response which might list the requirements for a response, e.g., Payment of $X plus access to patients DHR required to answer any technical questions. The question mark icon brings up a pop-up describing the content and its author-channel guide. The CFC can also function as a channel guide with icons which mark new content.

Lower LEFT Quadrant—iBillWell=Biller's and Collector's WEBSITE

This quadrant contains the ledger for the current patient. The ledger window allows for several different views, reports and drill-down.

LOWER RIGHT Quadrant=CFC=Clinical File Cabinet.

This quadrant may comprise a table listing or a simple text box containing a variety of different data. In an exemplary embodiment of the present invention, this window lists in table-format clinical historical data for the current patient. For example, this pane can contain a list of all consultations performed for this patient by doctors of the current medical organization, or a list of all consults currently in the patient's folder, or a list of all imaging studies for the patient or a list of all lab studies for a patient. In an exemplary embodiment of the present invention, this window contains medical coding guidelines specific for particular sections of a report. This window can contain medical guidelines for the treatment of patients with particular medical problems. This window can contain tools for constructing eProbes or report templates.

The word probe is used to refer to a set of query/response pairs that can be used to collect information in an ordered, structure manner for inclusion in a report. The “e” before “Probe” in “eProbe” refers to the word “embedded” because eProbes may be embedded in sections of a report. For example, an eProbe for a structured data set for the section called “vital signs” may contain various eQeuries (again, “e” for embedded), such as for example, blood pressure, heart rate and rhythm, respiratory rate, and body temperature and site measured. An eQuery can contain more than one datum. For example the eQuery for blood pressure may contain three datum: 1) systolic blood pressure, 2) diastolic blood pressure and 3) patient position when blood pressure measured.

An eProbe may have a variety of different formats, such as for example, list-, table- and/or iconic/picture-based. For example, a list of allergies could use a table-format eprobe, and the columns of the table could include: 1) agent, 2) reaction 3) date of first reaction 4) ever hospitalized for this allergy (Y/N). In an exemplary embodiment of the present invention, each item in each row of a table represents either a separate eQuery or elements of the same eQuery. The iconic/picture-based probe may use a background picture or icon and eQueries may be organized on a 2-D plane to demonstrate the data. For a given section of a report, one or more of section entry methods may be enabled as a data entry methodology for that section. Users, such as for example, engineers, healthcare providers, or organizations, can modify the allowed SEMs that can be used within their environment, for example, to support their desired workflow and organizational preferences/requirements. The data sources associated with the various section entry methods can also be varied. Data sources may include existing/historical patient health data, external resources, input from hardware devices, input from other documents.

In an exemplary embodiment of the present invention, each of the section entry methods is either a first type of section entry method (SEM) or a second type of SEM.

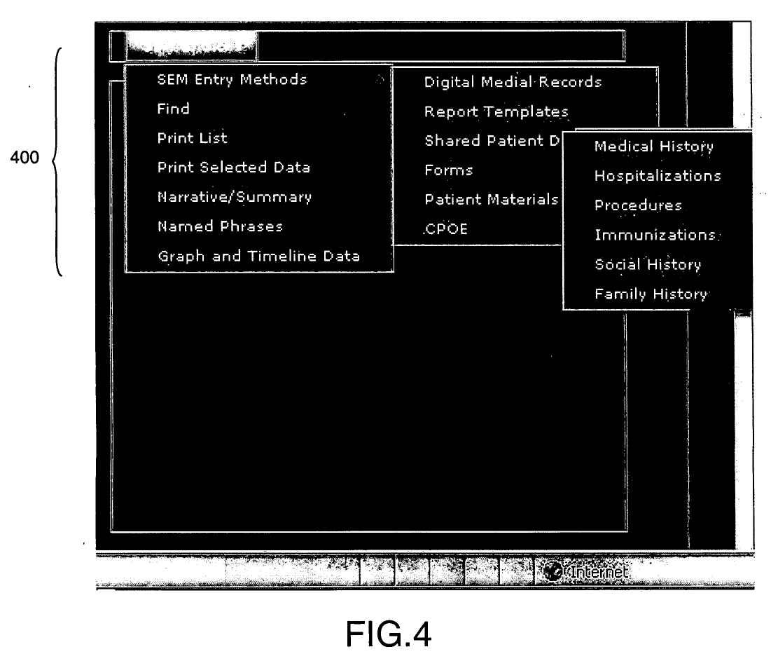

For example, the first type of SEM may be a data entry SEM and the second type of SEM may be an informational SEM. FIG. 2 shows a graphical user interface 200, including a section entry method panel 400, according to an exemplary embodiment of the present invention. FIG. 4 shows an enlarged view of the section entry method (SEM) panel 400 of the graphical user interface 200 of FIG. 2 showing SEM menus, according to an exemplary embodiment of the present invention.

A data entry SEM may comprise a picture, a video, a digital medical record, a voice recording, a link to data in a database, coding assistance information, a normal phrase, a form, a picture form, and/or person information.

An informational SEM may comprise a report part, a report section, a schedule, a glossary, a dictionary, a list of published literature references, a categorized list of ICD-9 codes to associate with a medical report, a categorized list of CPT codes to associate with a medical report, a categorized list of SNOMED codes to associate with a report section, an address book, information about disease treatment protocols, a medication list, and/or an organization's drug formulary.

Report parts and sections may be clicked into a medical report, for example, using the editor panel 300 of the graphical user interface 200 shown in FIG. 2. Schedules, for example of patient appointments, meetings, etc., may be displayed. Glossaries and/or dictionaries may be displayed. References such as lists of medical literature references may be displayed. A categorized list of ICD-9 codes to associate with the medical report may be displayed. A categorized list of CPT codes to associate with the medical report may be displayed. A categorized list of SNOMED codes for the report section may be displayed. Address books, such as for example, the PAB, may be displayed. Protocols, such as for example, information about disease treatment protocols appropriate for the patient's illness, may be displayed. Medication lists and/or formulary, such as for example, an organization's drug formulary may be displayed.

In a step 620, first user input is received selecting a first program process from the plurality of program processes. For example, selecting a first program process may comprise selecting a SEM as appropriate for the type of report section

In a step 630, a first insertion point is marked in the report section at a first user-selected position. The first user-selected position is selectable to allow a user to insert data at any position in the report section. It is to be understood that marking a first insertion point in the report section can be accomplished at any time prior to entering a first data into the report section. For example, although not shown as such in FIG. 6, a first insertion point may be marked in the report section prior to the step 620. Marking the insertion point at the user-selected position in the report section may comprise positioning a cursor at the user-selected position in the report section. For example, the cursor may be positioned using a mouse, a keyboard, and/or an assisted device. In an exemplary embodiment of the present invention, a second insertion point is marked in the report section at a second user-selected position, the second user-selected position being selectable to allow the user to insert data at any position in the report section.

In a step 640, a first data is entered into the report section at the first insertion point using the first program process.

Hereinafter, a computer readable medium including computer code for method of data entry into a section of a report as appropriate for a type and source of data and a type of report section, in accordance with an exemplary embodiment of the present invention will be described. The computer readable medium comprises: computer code for displaying a graphical user interface (GUI) comprising information indicating a plurality of program processes as appropriate for the type of report section; computer code for; computer code for receiving first user input selecting a first program process from the plurality of program processes; computer code for marking a first insertion point in the report section at a first user-selected position, the first user-selected position being selectable to allow a user to insert data at any position in the report section; and computer code for entering a first data into the report section at the first insertion point using the first program process.

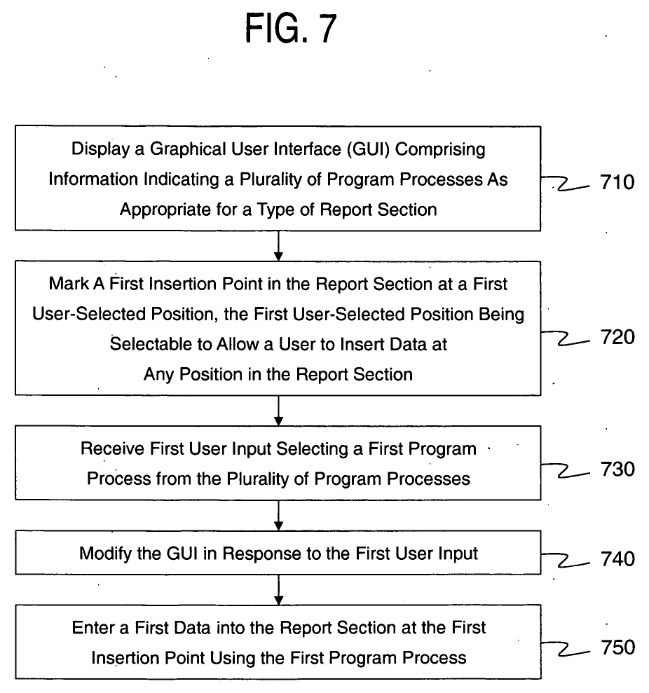

FIG. 7 is a flowchart showing a method of data entry into a section of a report as appropriate for a type and source of data and a type of report section, according to an exemplary embodiment of the present invention.

Referring to FIG. 7, in a step 710, display a graphical user interface (GUI) comprising information indicating a plurality of program processes as appropriate for the type of report section. In an exemplary embodiment of the present invention, the type of report section is selected by the user. The information indicating a plurality of program processes may comprise a list of section entry methods appropriate for the type of report section.

In an exemplary embodiment of the present invention, each of the section entry methods is either a first type of section entry method (SEM) or a second type of SEM. The first type of SEM may be a data entry SEM and the second type of SEM may be an informational SEM, for example as described above, with regard to an exemplary embodiment of the present invention shown in FIG. 6.

In a step 720, a first insertion point is marked in the report section at a first user-selected position, the first user-selected position being selectable to allow a user to insert data at any position in the report section. Marking the insertion point at the user-selected position in the report section may comprise positioning a cursor at the user-selected position in the report section. For example, the cursor may be positioned using a mouse, a keyboard, and/or an assisted device. In a step 730, first user input is received selecting a first program process from the plurality of program processes.

In a step 740, the GUI is modified in response to the first user input. For example, modifying the GUI may comprise displaying information useable in guiding the user in specifying desired functionality for the first program process. In an exemplary embodiment of the present invention, displaying information useable in guiding the user in specifying desired functionality for the first program process comprises displaying objects, including at least one of objects representing virtual devices having controls or objects that can be clicked into an editor panel of the GUI.

In a step 750, a first data is entered into the report section at the first insertion point using the first program process.

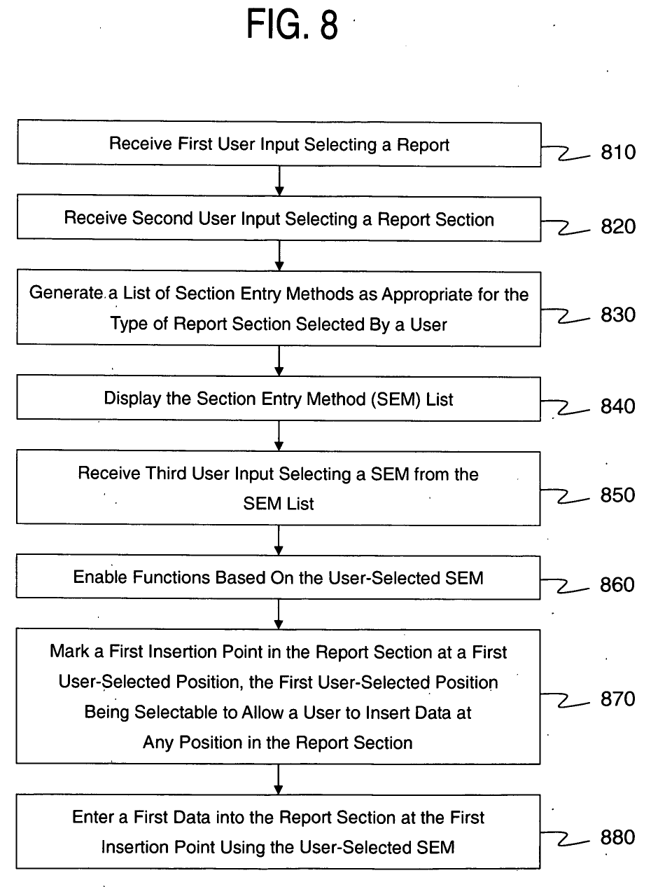

FIG. 8 is a flowchart showing a method of data entry into a section of a report as appropriate for a type and source of data and a type of report section, according to an exemplary embodiment of the present invention.

Referring to FIG. 8, in a step 810, a first user input is received selecting a report. For example, the report may be a medical report, client report, engineering report, research report, tax report, accounting report, accident report, inventory report, business report, insurance report, financial report, government report, or documentation report. In a step 820, a second user input is received selecting a report section.

In a step 830, a list of section entry methods is generated as appropriate for the type of report section selected by a user. In a step 840, the section entry method (SEM) list is displayed. For example, the SEM list may be displayed using a graphical user interface (GUI). The GUI may include a SEM panel and an editor panel. The SEM panel may contain at least one hierarchical menu that is displayed using the GUI.

Based on the type of SEM selected for display in the SEM panel, different functions may be enabled. For example, in the case of SEMs that are used as a means to enter data into a medical report section, activating the SEM may populate the SEM panel with the specified device and associated controls, or display objects in the SEM panel that can be clicked into the Doctations Editor. Informational SEMs, may be displayed in the SEM panel as an ordered set of active links; clicking on one provides more detailed information about the selected item.

In a step 850, a third user input is received selecting a SEM from the SEM list. In an exemplary embodiment of the present invention, each of the SEMs is either a first type of SEM or a second type of SEM.

In a step 860, functions are enabled based on the user-selected SEM. Enabling functions based on a user-selected SEM may comprise enabling functions based on whether the user-selected SEM is a first SEM type or a second SEM type. For example, as described above with respect to an exemplary embodiment of the present invention shown in FIG. 6, the first type of SEM may be a data entry SEM and the second type of SEM may be an informational SEM. In an exemplary embodiment of the present invention, enabling functions based on the user-selected SEM comprises retrieving data associated with the SEM from a data source. Data sources suitable for implementing the present invention include, but are not limited to, electronic files, databases, the Web, or databases via the Web, existing/historical patient health data, external resources, input from hardware devices, input from other documents.

In a step 870, a first insertion point is marked in the report section at a first user-selected position, the first user-selected position being selectable to allow a user to insert data at any position in the report section. Marking the insertion point at the user-selected position in the report section may comprise positioning a cursor at the user-selected position in the report section, for example, using a mouse, a keyboard, and/or an assisted device.

In a step 880, a first data is entered into the report section at the first insertion point using the user-selected SEM.

Hereinafter, a computer readable medium including computer code for method of data entry into a section of a report as appropriate for a type and source of data and a type of report section, in accordance with an exemplary embodiment of the present invention will be described. The computer readable medium comprises: computer code for receiving first user input selecting a report; computer code for receiving second user input selecting a report section; computer code for generating a list of section entry methods as appropriate for the type of report section selected by a user; computer code for displaying the section entry method (SEM) list; computer code for receiving third user input selecting a SEM from the SEM list; computer code for enabling functions based on the user-selected SEM; computer code for marking a first insertion point in the report section at a first user-selected position, the first user-selected position being selectable to allow a user to insert data at any position in the report section; and computer code for entering a first data into the report section at the first insertion point using the user-selected SEM.

Although the exemplary embodiments of the present invention have been described in detail with reference to the accompanying drawings for the purpose of illustration, it is to be understood that the that the inventive processes arid systems are not to be construed as limited thereby. It will be readily apparent to those of ordinary skill in the art that various modifications to the foregoing exemplary embodiments can be made therein without departing from the scope of the invention as defined by the appended claims, with equivalents of the claims to be included therein.

What is claimed is:

1. A computer-based method of media or data entry into a section of a report via an electronic network, comprising:
displaying a graphical user interface (GUI) comprising information indicating a plurality of program processes;
receiving first user input selecting a first program process from the plurality of program processes;
marking a first insertion point in the report section at a first user-selected position, the first user-selected position being selectable to allow a user to insert data at any position in the report section; and
entering a first data into the report section at the first insertion point using the first program process.

2. The computer-based method of claim 1, wherein the first data entry comprises at least one of a picture, a video, a digital medical record, a voice recording, a link to data in a database, a coding assistance information; a normal phrase, a form, a picture form, a person information, a report part, a report section, a schedule, a glossary, a dictionary, a list of published literature references, a categorized list of ICD-9 codes to associate with a medical report, a categorized list of CPT codes to associate with a medical report, a categorized list of SNOMED codes to associate with a report section, an address book, information about disease treatment protocols, a medication list, or an organization's drug formulary.

3. The computer-based method of claim 1, further comprising modifying the GUI in response to the first user input, wherein modifying the GUI comprises displaying information useable in guiding the user in specifying desired functionality for the first program process.

4. The computer-based method of claim 3, wherein displaying information useable in guiding the user in specifying desired functionality for the first program process comprises displaying objects, including at least one of objects representing virtual devices having controls or objects that can be clicked into an editor panel of the GUI.

5. The computer-based method of claim 1, further comprising marking a second insertion point in the report section at a second user-selected position, the second user-selected position being selectable to allow the user to insert data at any position in the report section.

6. The computer-based method of claim 5, further comprising entering a second data into the report section at the second insertion point using a second program process.

7. A computer readable medium having program instructions stored thereto for implementing the method claimed in claim 1 when executed in a digital processing device.

8. A computer-based method of media or data entry into a section of a report, comprising:
receiving first user input selecting a report;
receiving second user input selecting a report section;
generating a list of section entry methods based on the type of report section selected by a user;
displaying the section entry method (SEM) list;
receiving third user input selecting a SEM from the SEM list;
enabling functions based on the user-selected SEM;
marking a first insertion point in the report section at a first user-selected position, the first user-selected position being selectable to allow a user to insert data at any position in the report section; and
entering a first data into the report section at the first insertion point using the user-selected SEM.

9. The computer-based method of claim 8, further comprising a graphical user interface (GUI), wherein the GUI includes a SEM panel and an editor panel.

10. The computer-based method of claim 9, wherein the GUI is divided into four quadrants such that an upper left quadrant comprises a front desk, an upper right quadrant comprises a communication center, a lower left quadrant comprises a document editor (DE), and a lower right quadrant comprises a clinical file cabinet (CFC).

11. The computer-based method of claim 8, wherein enabling functions based on a user-selected SEM comprises enabling functions based on whether the user-selected SEM is a data entry SEM or an informational SEM.

12. The computer-based method of claim 11, wherein the data entry SEM comprises at least one of a picture, a video, a digital medical record, a voice recording, a link to data in a database, a coding assistance information., a normal phrase, a form, a picture form or a person information.

13. The computer-based method of claim 11, wherein the informational SEM comprises at least one of a report part, a report section, a schedule, a glossary, a dictionary, a list of published literature references, a categorized list of ICD-9 codes to associate with a medical report, a categorized list of CPT codes to associate with a medical report, a categorized list of SNOMED codes to associate with a report section, an address book, information about disease treatment protocols, a medication list, or an organization's drug formulary.

14. The computer-based method of claim 8, wherein enabling functions based on the user-selected SEM comprises retrieving data associated with the SEM from a data source.

15. A computer readable medium having program instructions stored thereto for implementing the method claimed in claim 8 when executed in a digital processing device.

16. A graphical user interface for use in entry of information in a medical report via an electronic network, comprising:
a plurality of sections presentable to the user including:
a first section for entry of patient administration information;
a second section presented with data transfer functions including at least one virtual media entry device;
a third section presented with a menu of selectable various patient data and data entry and editing functions; and
a forth section presented with selectively retrievable clinical data specific to the user.

17. The graphical user interface of claim 16, wherein patient administration information comprises at least one of a list of messages, a document requiring a signature, a list of signed-in patients, or schedule data.

18. The graphical user interface of claim 16, wherein the second section includes controls that allow the user to browse a disk drive and upload files for storage with the patient's chart.

19. The graphical user interface of claim 16, wherein the third section operates in connection with the second section to allow recording audio, images and video directly into text in a document.

20. The graphical user interface of claim 16, wherein the forth section comprises medical coding guidelines specific for particular sections of a report.
